(19) United States
(12) Patent Application Publication
(10) Pub. No.: US 2021/0383562 A1
(43) Pub. Date: Dec. 9, 2021

(54) Off-axis Observation for Moving Target Ranging

(71) Applicant: Izak Jan van Cruyningen, Saratoga, CA (US)

(72) Inventor: Izak Jan van Cruyningen, Saratoga, CA (US)

(21) Appl. No.: 17/337,384

(22) Filed: Jun. 2, 2021

Related U.S. Application Data
(60) Provisional application No. 63/035,450, filed on Jun. 5, 2020.

(51) Int. Cl. G06T 7/55; G06T 7/20; H04N 5/232

(52) U.S. Cl. CPC G06T 7/55; G06T 7/20; G06T 2207/30252; G06T 2207/10028; H04N 5/23299

(57) ABSTRACT

To improve range and approach speed measurements of targets moving relative to a camera using computer vision techniques, aim the camera away from the direction to the target to capture the target closer to the edge of the field of view.

### CROSS-REFERENCE TO RELATED APPLICATIONS

This application claims the benefit of provisional patent application Ser. No. 63/035,450 filed 2020 Jun. 5 by the present inventor.

### FIELD

This invention relates to measuring range and approach speed for targets moving relative to a camera using computer vision algorithms.

### BACKGROUND—PRIOR ART

Detecting and avoiding collisions for vehicles, whether cars on roads, ships at sea, or aircraft in the sky, enhances safety. Cameras are mounted on vehicles to help detect potential collisions. Then computer vision techniques, such as background subtraction and segmentation, are used to identify which parts of the image contain targets. Suppose a vehicle with an estimated characteristic size approaches a camera. The range to the vehicle can be calculated from its size in image space using the geometric properties of the camera. A second image taken a few moments later provides a second range which can be combined with the first to measure approach speed. The range to the vehicle divided by the approach speed gives the time to a potential collision to help in deciding an avoidance maneuver.

Vehicles moving directly towards each other have the potential for some of the worst damage since the kinetic energy of impact is the sum of the two vehicle's kinetic energies. Unfortunately, this case is one of the hardest to detect since an image of a distant approaching vehicle changes size slowly. The approach speed is the sum of the two vehicle speeds, so the detection must be done quickly and accurately.

If the collision detection camera is oriented away from the target, then the representation in image space not only increases in size but also moves across the field of view. Computer vision algorithms perform better on changes that include both scaling and translation, rather than scaling alone. This leads to the counterintuitive idea that to best detect an approaching vehicle, aim the camera to the side in an off-axis direction. Rather than pointing the collision detection camera directly at the target to determine how far away the target is and how fast it is moving, aim away and catch it off-center. People naturally look directly at an object to estimate range and approach speed. Automated detection using computer vision algorithms will perform better with cameras looking out of the “corner of their eye.” Collision detection cameras on vehicles should be cross-eyed or wall-eyed.

In remote sensing, oblique images provide height information in addition to surface features. Cameras are mounted obliquely to measure terrain (U.S. Pat. No. 7,424,133B2 and US20160044239A1) or inspect infrastructure (U.S. Pat. No. 10,217,207B2) with a variety of mounting methods (WO2019119939A1, CN107340672A, or CN105323485A). Astronomers teach themselves to look obliquely at stars to take advantage of the better sensitivity of the rods outside the fovea than the cones within it.

### SUMMARY

To improve range and approach speed measurements of targets moving relative to a camera using computer vision techniques, aim the camera away from the direction to the target to capture the target closer to the edge of the field of view.

### ADVANTAGES

Aiming a target detection camera off-axis away from the direct line to the target supplements scaling in the image space with translation. The additional information from translation makes it easier to detect the target, calculate its range, and measure the approach speed accurately.

Other advantages of one or more aspects will be apparent from a consideration of the drawings and ensuing description.

### FIGURES

FIG. 1. Perspective view of a camera aimed at a target with sample images taken at two points in time (prior art).

FIG. 2. Geometry of estimating range from scale changes (prior art).

FIG. 3. Perspective view of a camera aimed away from the direction to a target with sample images taken at two points in time.

FIG. 4. Plan view of six cameras for 360° detection mounted on top of an aircraft.

FIG. 5. Flowchart for calculating range and approach speed.

### DETAILED DESCRIPTION

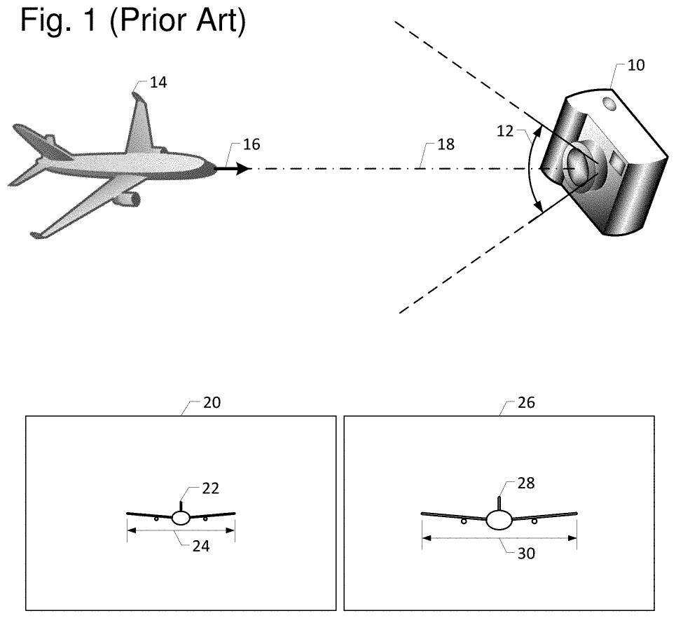

This section describes several embodiments of the method to calculate range and approach speed with reference to FIGS. 1-5.

FIG. 1 is a perspective view of a camera 10 with angle of view 12 aimed at target 14 moving in direction 16. Camera 10 is aimed towards target 14 with direction to target 18 approximately in the middle of angle of view 12. First image 20 acquired by camera 10 has a representation of target 22 near the center of image 20 with a width in pixels 24. Target 14 is moving in direction 16 towards camera 10. Second image 26 taken at a later time contains a representation of target 28 near the center of image 26 with a larger width in pixels 30. The change in scale between width in pixels 24 and width in pixels 30 allows calculation of range and approach speed.

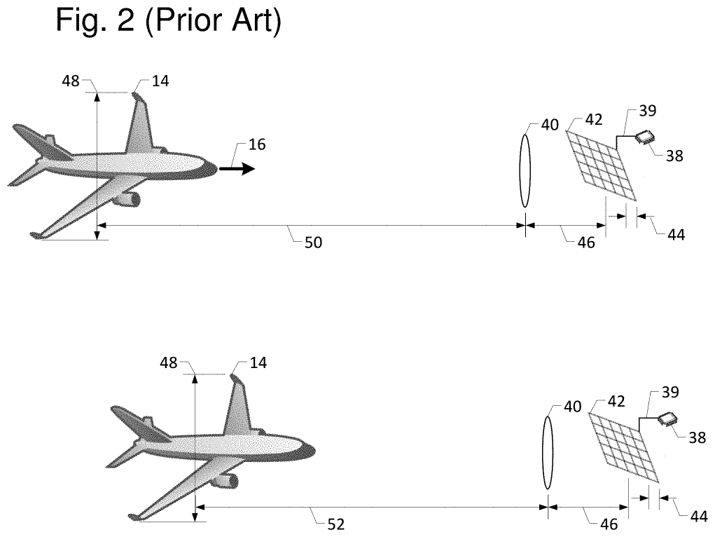

FIG. 2 illustrates the geometry to measure range. Camera 10 contains lens 40 and focal plane array 42 with pixel pitch 44. Lens 40 and focal plane array 42 are separated by approximately the focal length 46. Target 14 with a characteristic dimension 48 moving 16 towards lens 40 in camera 10 is at first range 50 when first image 20 is captured. Target 14 is at second range 52 when second image 26 is captured some time later. Processor and memory 38 communicating over a wire 39 or wirelessly is used to detect target 14 and calculate first range 50, second range 52, and approach speed.

Camera 10 has a two-dimensional sensor 42 placed in the image plane capturing, for example, visible, near infrared, ultraviolet, or thermal infrared wavelengths. It may use, for example, CCD, CMOS, or micro bolometer sensing. Processor and memory 38 may be integral to camera 10 or in an external module communicating 39 with it.

To calculate first range 50 from first image 20, use similar triangles. The calculation is characteristic dimension 48 times focal length 46 divided by the product of width in pixels 24 and pixel pitch 46.

The same calculation for second range 52 from second image 26 is characteristic dimension 48 times focal length 46 divided by the product of width in pixels 30 and pixel pitch 46. Subtracting second range 52 from first range 50 gives the range difference during the time between taking first image 20 and second image 26. Dividing this range difference by the time difference gives the first target approach speed.

The calculated approach speed is relative: camera 10 may be stationary and target 14 moving towards it with approach speed 16; target 14 and camera 10 may both be moving; or camera 10 may be approaching a stationary target.

Focal length 46 can be measured accurately using photogrammetric methods. Manufacturing of focal plane array 42 gives the precise pixel pitch 44. Characteristic dimension 48 stays the same for both range calculations. The biggest uncertainty in estimating the approach speed is measuring the width in pixels 24 and width in pixels 30 of representations of target 22 and 28.

The US Army estimates it can distinguish a truck from a tank if the vehicle subtends four pixels and identify the tank attributes in 7 pixels. The National Transportation Safety Board (NTSB) estimates that an aircraft must subtend at least 12 minutes of visual arc before there is a reasonable chance of it being seen by a human pilot. A person with 20/20 vision has acuity of about one arcminute.

As an example, suppose target 14 is a small general aviation aircraft with a wing span characteristic dimension of 10 m and camera 10 has a focal length of 6 mm and pixel pitch of 2 μm. Then the general aviation aircraft will subtend 12 pixels at first range 50 of 10*0.006/(12*0.000002)=2500 m.

A half pixel error in measuring width in pixels 24 will give a 100 m error in range.

If second image 26 is taken two seconds after first image 20 and width in pixels 30 is measured as 13 pixels, then the calculated range is 2308 m and the calculated approach speed is (2500−2308)/2=96 m/s or 187 knots. However, a half pixel error in measuring width in pixels 24 gives approach speed of 46 or 151 m/s, or 50% smaller or larger than an accurate measurement. Any error in measuring width in pixels 30 further increases this uncertainty.

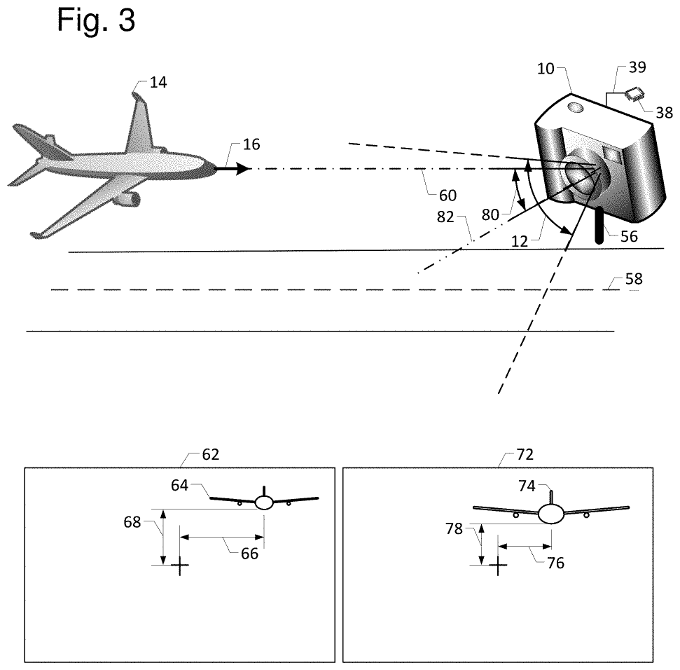

FIG. 3 illustrates an off-axis alignment. Camera 10 on a fixed mount 56 adjacent to runway 58 with angle of view 12 encompasses target 14 moving in direction of travel 16. In contrast to FIG. 1, direction to target 60 is near the edge of angle of view 12 at off-axis angle 80 relative to camera principal axis 82. First image 62 acquired by camera 10 has representation of target 64 away from the center of first image 62 at a horizontal offset in pixels 66 and vertical offset in pixels 68. Second image 72 taken some time later has a larger representation of target 74, as illustrated in FIG. 1, but also a different horizontal offset in pixels 76 and vertical offset in pixels 78. Processor and memory 38 communicates with camera 10 through a wire 39 or wirelessly.

The calculation of range and approach speed based on the change of scale is the same as in FIG. 1 and FIG. 2 as explained in paragraphs [0012] [0013] with an example in [0017] and [0018]. However there is additional information available to reduce the uncertainty, namely the translation between representation 64 and representation 74 as the difference between horizontal offset in pixels 76 and 66 and the difference in vertical offset in pixels 78 and 68. An off-axis alignment captures not only a change in scale, but also a translation. Counterintuitively, looking out of the corner of lens 40 provides more information than looking directly at the target. The additional information can help reduce the 50% uncertainty described in paragraph [0018].

Camera 10 is adjacent runway 58, but aimed somewhat across the runway, rather than straight down it to create off-axis angle 80. Similarly a camera could be mounted adjacent roads to detect cars or adjacent bike paths to detect bicycles. The runway, roadway, and bike path are examples of vehicle pathways that direct traffic alongside the camera, with vehicle motion relative to a fixed camera.

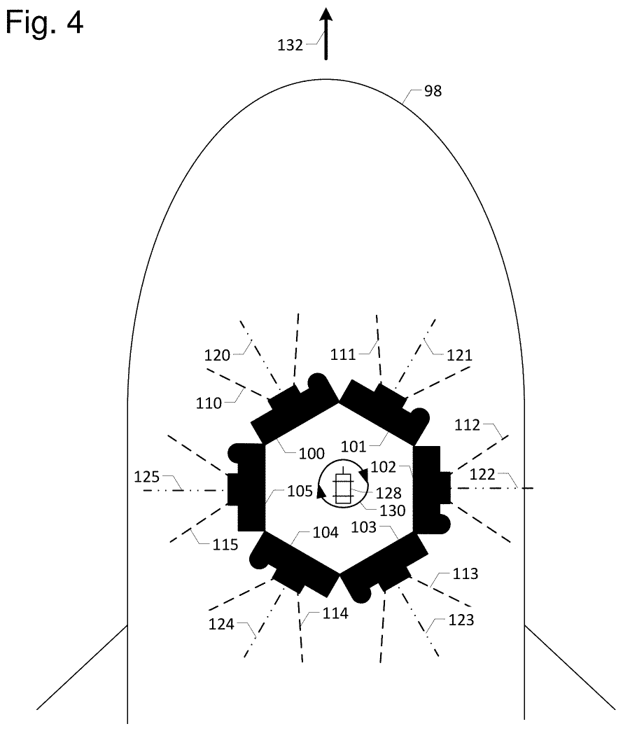

FIG. 4 is a plan view of six cameras mounted on top of aircraft 98 to capture a 360° angle of view. This arrangement could be used on aircraft to detect aircraft approaching from any direction or on a ship at sea detecting other vessels in any direction. Camera 100 with horizontal angle of view 110 and optical axis 120, camera 101 with angle of view 111 and optical axis 121, camera 102 with angle of view 112 and optical axis122, camera 103 with angle of view 113 and optical axis 123, camera 104 with angle of view 114 and optical axis 124, and camera 105 with angle of view 115 and optical axis 125 are mounted in a circle on aircraft 98 travelling in direction 132. Optionally, the cameras are mounted on motor 128 that is fixed to airframe 98 and can rotate 130 the cameras.

To continue the sample calculation in paragraphs [0017] and [0018], suppose each of the six cameras has a focal plane array 4000 pixels across. Then each horizontal angle of view 110 through 115 would be 67° for a 3½° overlap between adjacent cameras. Rather than pointing in direction of motion 132, camera 100 with optical axis 120 and camera 101 with optical axis 121 are each 30° off-axis to either side of the direction of motion 132. Fixed wing airframes, most vehicles on land, and ships at sea have a well-defined direction of motion. This is the most likely direction of approach for a target, so cameras can be mounted directly to the frame, off-axis to the direction of motion, as shown. For vehicles on roads, by far the most likely approach of targets is from ahead, so two cameras could be fixed facing forward and wall-eyed. For rear-end collisions or backing up, two cameras are fixed facing backwards and wall-eyed.

Hovercraft and rotary wing airframes, like helicopters and UAV multicopters, can travel in any direction. To provide off-axis images the six cameras are mounted on a motor 128 that is mounted on airframe 98. Motor 128 can rotate 130 the cameras either to a specific off-axis angle with respect to the direction of motion, or continuously.

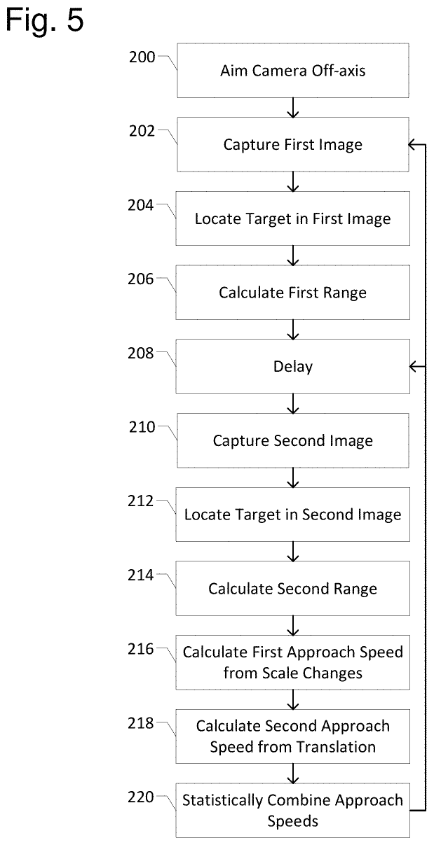

FIG. 5 is a flowchart for improving the calculation of range and approach speed for a target 14 moving relative to camera 10. First aim the camera off-axis 200 as illustrated in FIG. 3. For a car on a road, a ship at sea, or a fixed wing aircraft, the primary obstacles will be in front so the most important cameras will face forward at an off-axis angle to the direction of travel. A larger angle produces a larger translation of the representations of the target in the images, thereby improving measurements of approach speed, but the off-axis angle must be small enough to keep the target within the field of view.

For a camera stationed alongside an airport runway with aircraft landing, aim the camera at an off-axis angle to the runway and aircraft approach path, as illustrated in FIG. 3. Likewise for cameras along a road, aim into the traffic at an off-axis angle to the road. The runway and road can be considered as vehicle pathways to channel traffic.

To detect targets approaching from any direction, you can either mount a plurality of cameras as shown in FIG. 4; rotate a camera around a vertical axis for a car on a road or a ship at sea; or rotate around two axes for an aircraft in the sky.

After aiming the camera off-axis 200, next capture a first image 202, locate the target in the first image 204, and calculate the first range 206. Locating the representation of the target in an image can be done with a number of different computer vision and machine learning algorithms, depending on the target and background visibility. This includes image segmentation, template matching, machine learning, deep learning, and other approaches. Calculating the first range is described in paragraphs [0012] [0013] with an example in [0017] and [0018]. The characteristic dimension for the target depends on the application domain and target detected. For a car on a road it could be the width and length of other cars ˜two by five meters, the width of a stop sign ˜¾ m, or the height of a street sign ˜2 m. For a ship it could be beam and length, and for an aircraft it could be wingspan and length.

The delay 208 time depends on the domain and the first range calculated. For relatively slow ships far away at sea it can be multiple seconds; for faster cars on roads it will be shorter; and for jets in the air it must be very short because the approach speed is so much faster. This sequence of steps does not have to be strictly sequential, for example, steps 204 and 206 could be computed in parallel with the delay 208.

After the delay 208, capture second image 210, locate target in second image 212, and calculate second range 214, as described in paragraphs [0012] [0013].

Calculate the first approach speed from scale changes 216 by subtracting the second range from the first and dividing by the delay time.

Calculate the second approach speed from translation of the target in the image 218, i.e. the difference in horizontal offsets 66 and 76 and the difference in vertical offsets 68 and 78. The math is not as easy to describe as for scale changes. In, for example, “Geometric model for an independently tilted lens and sensor with application for omnifocus imaging” (2017) Applied Optics Vol. 56, Issue 9, pp. D37-D46, Sinharoy, Rangarajan, and Christensen develop a model with closed form equations and an inter-image homography matrix. The equations or matrix can be implemented on processor and memory 38 to calculate a second approach speed from translation 218. A matrix-based approach could combine some of the calculations for first range, second range, first approach speed, and second approach speed.

The first and second approach speeds are statistically combined 220 to provide a more robust measurement of true approach speed. This could be a simple average, a geometric average, a weighted average, or another statistical combination.

A weighted average could be based on confidence in the measurement. For example, if the representation of the target was detected near the center of the images, the translation between them will be very small and produce significant measurement errors. The weighting for the second approach speed from translation 218 could be reduced, relative to first approach speed from scale 216. If no translation is detected then the weighting is close to zero.

Conversely, suppose the delay time 208 is short so it is difficult to measure a change in scale between the images, but there is a translation of the representation at the edge of the field of view. Then the weighting of the first approach speed from scale changes 216 is reduced, potentially as small as zero, relative to the second approach speed from translation 218.

After statistically combining approach speeds 220 to provide a more robust measurement, treat the second image as a new first image and repeat the delay 208 and second image capture, or circle back to capture a new first image 202.

This application illustrated details of specific embodiments, but persons skilled in the art can readily make modifications and changes that are still within the scope. For example, FIG. 4 showed six similar cameras in a plane. There can be any number of cameras and they do not have to be similar nor in a plane. In fact it would be advantageous to have more cameras with narrower fields of view facing off-axis to the direction of motion. Two cameras with 45° angles of view facing 20° away from forward direction 132 would have a range of 4000 m instead of 2500 m calculated above. Mounting two more cameras out of plane facing 20° off-axis up and down would improve detection in the forward direction even more.

I claim:

1. A method for measuring range and approach speed between a camera and a target in relative motion comprising:
aiming the camera optical axis away from the direction to the target, but with the target still within the camera field of view,
capturing a first image containing the target with the camera,
locating the representation of the target in the first image,
calculating a first range to the target from a characteristic dimension of the target, the camera focal length, and the size of the target in its representation in the first image,
capturing a second image containing the target with the camera at a later point in time,
locating the representation of the target in the second image,
calculating a second range to the target from a characteristic dimension of the target, the camera focal length, and the size of the target in its representation in the second image,
calculating a first approach speed by subtracting the second range from the first range and dividing the result by the difference in image capture times,
calculating a second approach speed from the translation of the target in its representation in the second image relative to its representation in the first image,
statistically combining the first approach speed and the second approach speed to get a more accurate measure of true approach speed.

2. The method of claim 1 wherein said camera is mounted adjacent a vehicle pathway with optical axis away from the direction of vehicle traffic.

3. The method of claim 1 wherein said aiming is a fixed mount on a vehicle with the camera optical axis off the direction of motion of the vehicle.

4. The method of claim 1 wherein the camera is attached to a motor attached to a vehicle and said aiming rotates the camera with the motor relative to the direction of motion of the vehicle.

5. The method of claim 1 wherein said statistically combining weights the contributions of first approach speed and the second approach speed depending on how far the representation of the target is from the center of the image.

6. A target range and approach speed measurement system comprising:
a camera with optical axis aimed away from the target so the target is nearer the edge of the field of view of the camera,
a processor and memory to locate the target in a first image captured by the camera, calculate a first range from the size of the representation of the target in the first image,
locate the target in a second image captured by the camera at a later time,
calculate a second range from the size of the representation of the target in the second image,
calculate a first approach speed from the difference in first and second ranges and the elapsed time between capturing the first and second images,
calculate a second approach speed from the translation between the location of the representation of the target in the first image and the second image,
statistically combining the first approach speed with the second approach speed to get a more accurate measure of the true approach speed.

7. The apparatus of claim 6 further comprising a mount for said camera to position it adjacent to a vehicle pathway, aimed away from the vehicle direction of travel.

8. The apparatus of claim 6 further comprising a mount for said camera to mount it on a vehicle, aimed away from the direction of travel of the vehicle.

9. The apparatus of claim 6 further comprising a motor mounted to a vehicle with a mount for said camera, whereby the motor can rotate said camera away from the direction of travel of the vehicle.
